(19) United States
(12) Patent Application Publication
(10) Pub. No.: US 2009/0265569 A1
(43) Pub. Date: Oct. 22, 2009

(54) POWER CONTROL METHOD FOR COMPUTER SYSTEM

(76) Inventors: Noriaki YONEZAWA, Yokohama (JP); Yoshifumi Takamoto, Kokubunji (JP); Kazuo Horikawa, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/372,146

(22) Filed: Feb. 17, 2009

(30) Foreign Application Priority Data
Apr. 22, 2008 (JP) 2008-111085

(51) Int. Cl. G06F 1/00; G06F 3/00

(52) U.S. Cl. 713/324; 710/18; 713/320

(57) ABSTRACT

Provided is a computer system comprising: an input/output switch coupled to a plurality of input/output devices; a server which is coupled to the input/output switch and, which uses the plurality of input/output devices; and a management computer coupled to the input/output switch and the plurality of input/output devices. The management computer manages pieces of management information including a port of the input/output switch coupled to the each of the plurality of input/output devices, an association of a device coupled to the each of the plurality of input/output devices, and a usage ratio of the each of the plurality of input/output devices; selects at least one of the input/output devices of which the usage ratio is smaller than a first predetermined threshold according to the pieces of management information; and processes, by another input/output device coupled to the input/output switch, a request for the selected input/output device.

### CLAIM OF PRIORITY

The present application claims priority from Japanese patent application JP 2008-111085 filed on Apr. 22, 2008, the content of which is hereby incorporated by reference into this application.

### BACKGROUND OF THE INVENTION

This invention relates to a technique for controlling power of a computer system and more particularly relates to a method for reducing power consumption of an input/output device.

Devices such as a server, an external disk device, a network switch and a load balancer are included in the computer system. Power consumption of the devices is increasing due to an improvement in their performances. For that reason, the costs for power supply and cooling down for the devices in the computer system are largely increasing.

For input/output devices (hereinafter, refer to as I/O devices) in the computer system, the number of useable I/O devices was limited. Accordingly, a power saving effect was not a priority for the I/O devices before. Although the recent appearance of an I/O switch-incorporated blade server has increased the number of useable I/O devices, the power consumption of the I/O devices has been increasing, and thus, an improvement in power-saving for the I/O devices is required.

In JP 2007-243790 A, disclosed is a technique for improving power-saving by centralizing plural lines connecting between network switches in to one port and shutting down the power of port to which data is not transmitted (See JP 2007-243790 A).

### SUMMARY OF THE INVENTION

In the technique disclosed in JP 2007-243790 A, only the port for the network switches is used and it assumed that all the ports have the same functions. Accordingly, the technique does not apply to a case where a plurality of various I/O devices is used such as the I/O switch-incorporated blade server described above.

An object of this invention is to improve power-saving for the plurality of various I/O devices included in the system.

A representative aspect of this invention is as follows. That is, there is provided a power control method executed in a computer system including: an input/output switch connected to a plurality of input/output devices; a server which is connected to the input/output switch and, which uses the plurality of input/output devices; and a management computer connected to the input/output switch and the plurality of input/output devices. The management computer comprises: an interface connected to the input/output switch and the server; a processor connected to the interface; and a memory connected to the processor. The management computer is configured to: manage pieces of management information including a port of the input/output switch connected to the each of the plurality of input/output devices, an association of a device connected to the each of the plurality of input/output devices, and a usage ratio of the each of the plurality of input/output devices. The power control method includes the steps of: selecting at least one of the input/output device of which the usage ratio is smaller than a first predetermined threshold according to the pieces of management information; and processing, by another input/output device connected to the input/output switch, a request for the selected input/output device.

According to an aspect of this invention, the power consumption of the computer system can be reduced by centralizing (load-concentration) an I/O device with a small load into another I/O device.

### BRIEF DESCRIPTION OF THE DRAWINGS

The present invention can be appreciated by the description which follows in conjunction with the following figures, wherein:

FIG. 1 is a diagram showing a configuration of a computer system according to a first embodiment of this invention;

FIG. 2 is a diagram showing a configuration of a management server according to the first embodiment of this invention;

FIG. 3 is a diagram showing a configuration of a server according to the first embodiment of this invention;

FIG. 4 is a diagram showing a configuration of a storage system according to the first embodiment of this invention;

FIG. 5 is an explanatory diagram showing an outline of load-concentration for an I/O device according to the first embodiment of this invention;

FIG. 6 is a diagram showing an I/O switch management table according to the first embodiment of this invention;

FIG. 7 is a diagram showing a server management table according to the first embodiment of this invention;

FIG. 8 is a diagram showing a server I/O configuration information table according to the first embodiment of this invention;

FIG. 9 is a diagram showing a device pool management table according to the first embodiment of this invention;

FIG. 10 is a diagram showing a configuration of the I/O device according to the first embodiment of this invention;

FIG. 11 is a flowchart showing a process of an entire power control process of the I/O device according to the first embodiment of this invention;

FIG. 12 is a flowchart showing a process of monitoring power consumption of the I/O device by an I/O device power monitor module according to the first embodiment of this invention;

FIG. 13A is a flowchart showing a process of determining whether power-saving control on the I/O device is performed by an I/O device power-saving determination module according to the first embodiment of this invention;

FIG. 13B is a table showing determining whether power control on the I/O device is performed by the I/O device power-saving determination module according to the first embodiment of this invention;

FIG. 14 is a flowchart showing a process of selecting an I/O device subject to load-concentration by an I/O device selection module according to the first embodiment of this invention;

FIG. 15 is a flowchart showing a process of performing load-concentration on the I/O device by an I/O device load-concentration module according to the first embodiment of this invention;

FIG. 16 is a flowchart showing a process of performing load-unconcentration on the I/O device by an I/O device load-unconcentration module according to the first embodiment of this invention;

FIG. 17 is a flowchart showing a process of performing load-unconcentration and load-unconcentration on the I/O device by a virtual device control module according to the first embodiment of this invention;

FIG. 18 is a diagram showing a server management table according to a second embodiment of this invention; and

FIG. 19 is a flowchart showing a process of selecting an I/O device subject to load-concentration by an I/O device selection module according to the second embodiment of this invention.

### DETAILED DESCRIPTION OF THE PREFERRED EMBODIMENTS

Hereinafter, embodiments according to this invention are described with reference to the drawings.

### A First Embodiment

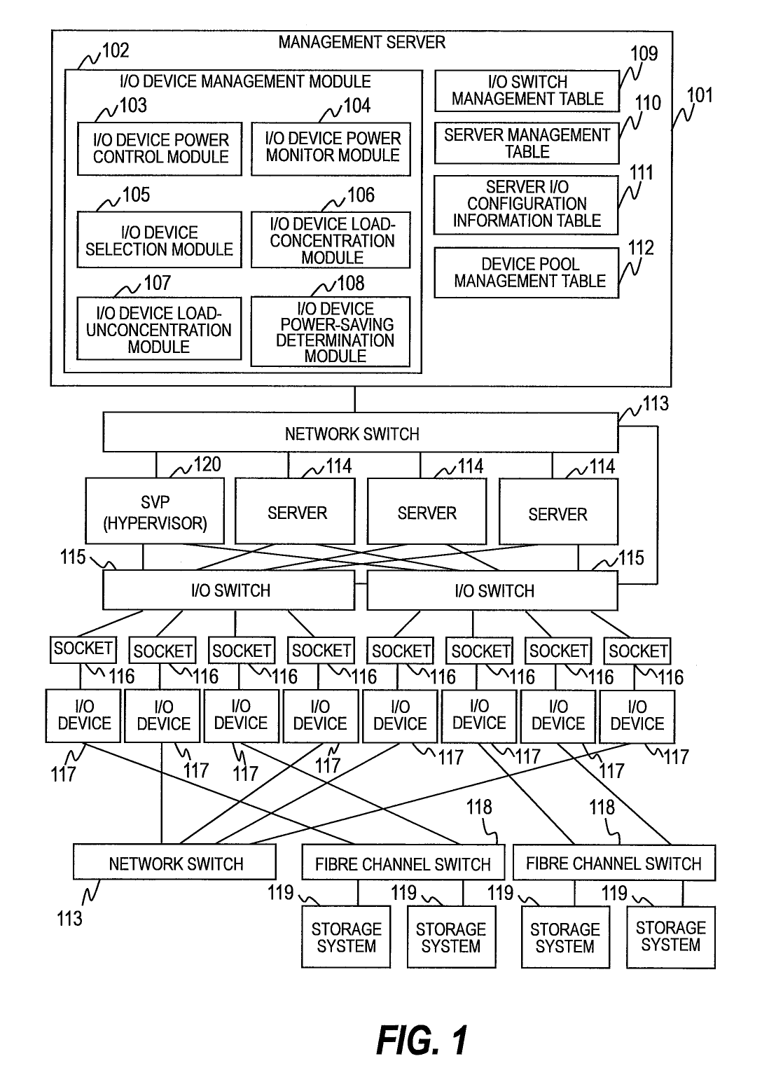

FIG. 1 is a diagram showing a configuration of a computer system according to a first embodiment of this invention.

The computer system according to the first embodiment of this invention comprises a management server (a management computer) 101, network switches 113, servers 114, an SVP (a Service Processor) 120, I/O switches 115, sockets 116, I/O devices 117, fibre channel switches 118 and storage systems 119.

The management server 101, the servers 114, the SVP 120 and the I/O switches 115 are connected to each other by a network such as Ethernet.

The management server 101 manages an entire computer system and each component. In the first embodiment of this invention, the management server 101 mainly manages the servers 114, the SVP 120 and the I/O switches 115. In addition, the management server 101 may manage the storage systems 119. The storage systems 119 may be managed by other computer.

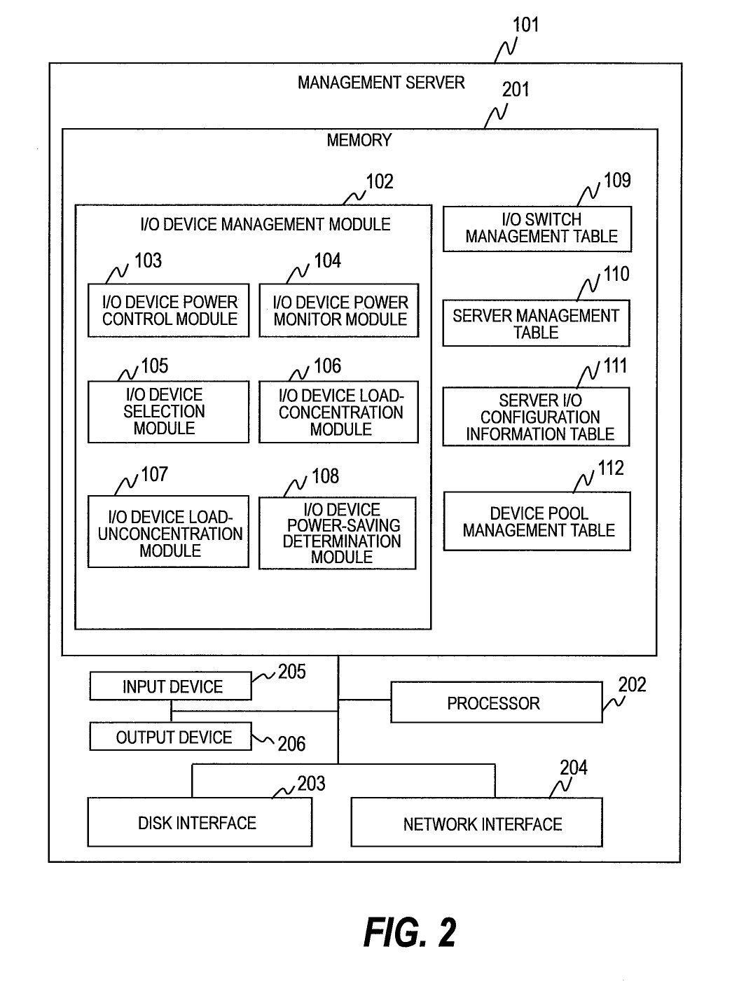

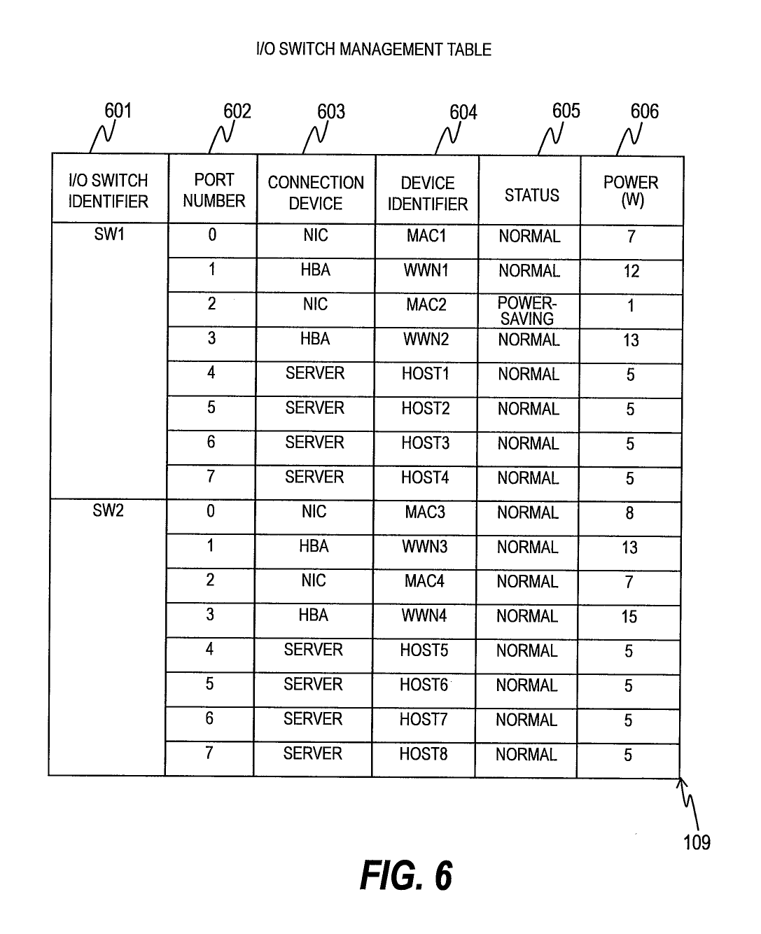

The management server 101 stores an I/O device management module 102 and various pieces of management information. The I/O device management module 102 includes an I/O device power control module 103, an I/O device power monitor module 104, an I/O device selection module 105, an I/O device load-concentration module 106, an I/O device load-unconcentration module 107, and an I/O device power-saving determination module 108. The various pieces of management information include an I/O switch management table 109, a server management table 110, a server I/O configuration information table 111 and a device pool management table 112. The configuration of the management server 101 will be described in FIG. 2. Moreover, each component will be described in detail in FIG. 6 and the subsequent figures.

The network switches 113 control paths of packets transferred on the network connecting devices in the computer system.

The SVP 120 cooperates with a hypervisor and virtualizes the servers by logically dividing computer resources included in the physical servers 114 and computer resources used by the servers 114, thereby provides logical servers. The SVP 120 operates and manages the physical servers and the logical servers in an integrated manner.

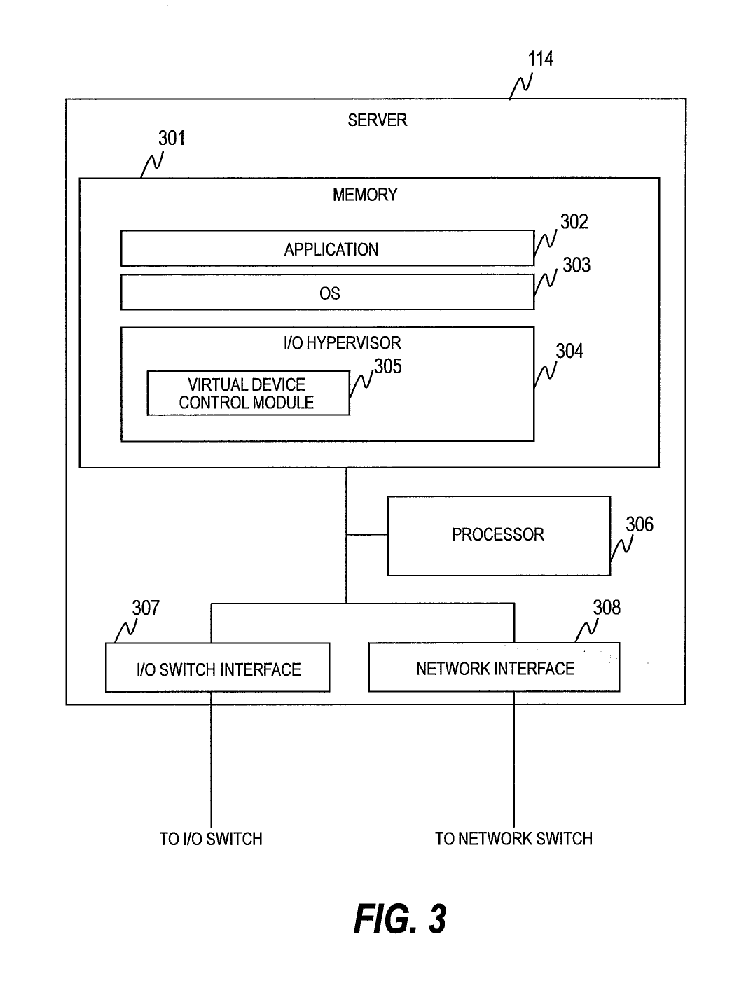

The servers 114 execute various task processes according to requests from users. The servers 114 are connected to the storage systems 119 via a storage area network (SAN) such as a fibre channel and the like. The configuration of the servers 114 will be later described with reference to FIG. 3.

The I/O switches 115 connect the servers 114 and the I/O devices 117 in a case where the servers 114 connect to an external network via the I/O devices 117. The sockets 116 connect the I/O devices 117.

The I/O devices 117 are interfaces for connecting to a network and the like. The examples are a network interface card (NIC) for connecting to the network by Ethernet, or a host bus adaptor (HBA) for connecting to the SAN. Moreover, the I/O devices 117 may be interfaces for connecting specific devices.

The fibre channel switches 118 connect various devices each other, which transmit and receive data via the SAN, and controls paths of data to be transferred. More specifically, the fibre channel switches 118 relays the servers 114 and the storage systems 119 in a case where the servers 114 transmit data to and receive data from the storage systems 119 via the I/O devices 117 which is a host adaptor.

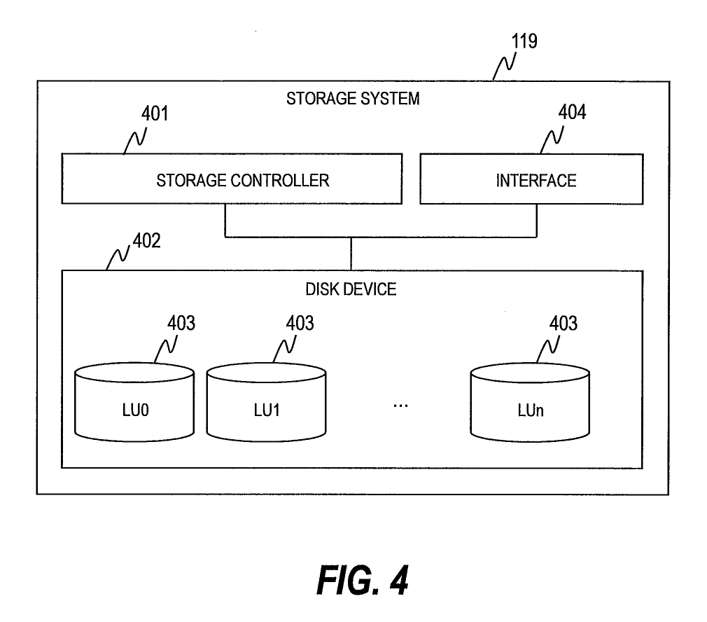

The storage systems 119 store data necessary for executing task process in the servers 114. The configuration of the storage systems 119 will be later described in FIG. 4.

FIG. 2 is a diagram showing a configuration of the management server 101 according to the first embodiment of this invention.

The management server 101 comprises a memory 201, a processor 202, an input device 205, an output device 206, a disk interface 203, and a network interface 204.

The memory 201 stores programs, such as an operating system (OS) and applications, and data used by the programs. More specifically, the memory 201 stores the I/O device management module 102 and the various pieces of management information. The I/O device management module 102 includes a program for controlling power of the I/O devices 117.

The processor 202 controls the computer system by executing programs stored in the memory 201. The input device 205 receives inputs such as instructions from users. The output device 206 outputs management information including results of the processing performed by the I/O device management module 102.

The disk interface 203 is an interface connected to the storage systems which store data or programs. For example, the disk interface 203 may be the HBA connected to the SAN or the NIC. More specifically, the disk interface 203 may be connected to the I/O switches 115 via the network switches 113 in order to connect the I/O devices 117 to the storage systems 119.

The network interface 204 is an interface connected to devices subject to be managed via the network.

Here, the further descriptions of the I/O device management module 102 and the various pieces of management information stored in the memory 201 are given.

As described above, the I/O device management module 102 includes the I/O device power control module 103, the I/O device power monitor module 104, the I/O device selection module 105, the I/O device load-concentration module 106, the I/O device load-unconcentration module 107, and the I/O device power-saving determination module 108.

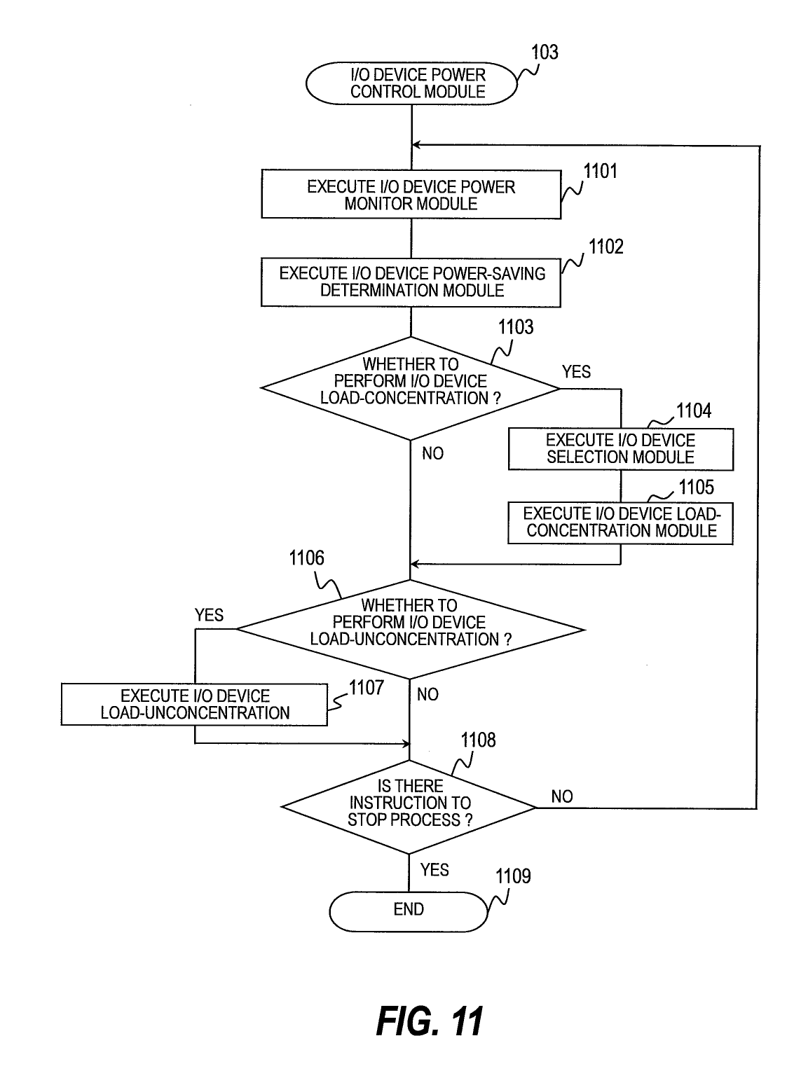

The I/O device power control module 103 controls the power of the I/O devices 117 by executing the I/O device power monitor module 104, which will be later described. The process will be later described in detail in FIG. 11.

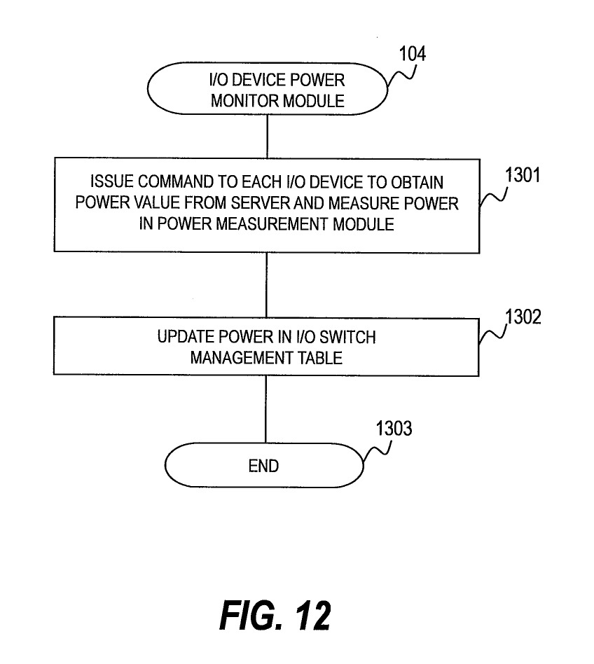

The I/O device power monitor module 104 monitors power measured in each I/O device 117 and records the measured power in the I/O switch management table 109. The process will be later described in detail in FIG. 12.

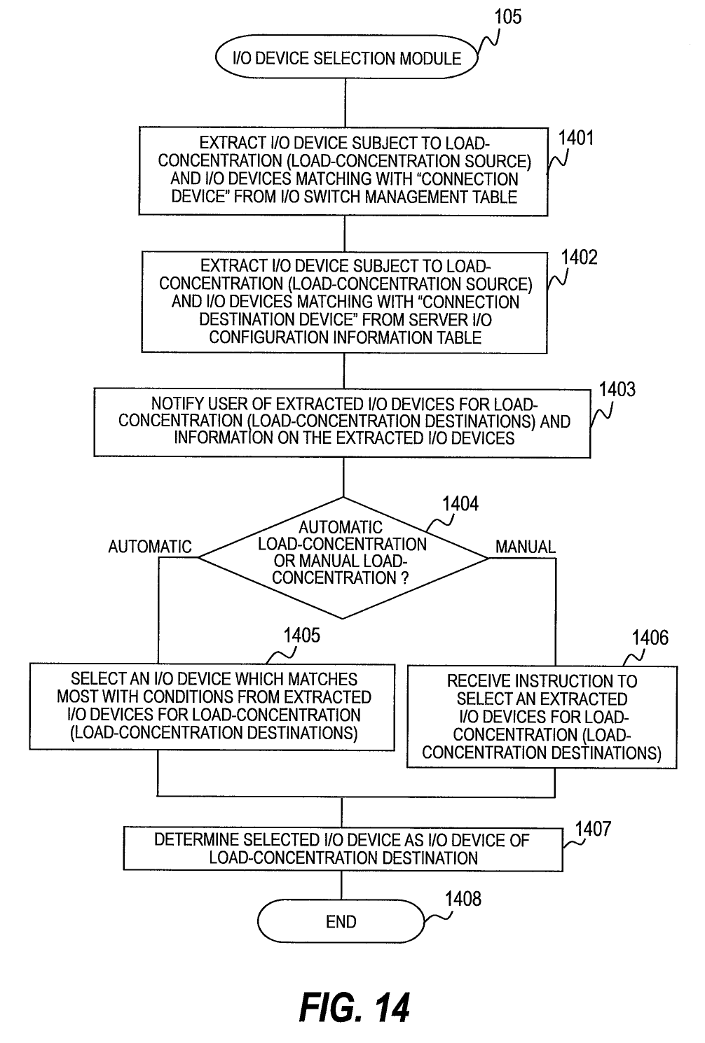

The I/O device selection module 105 selects I/O devices subject to load-concentration. As described above, the load-concentration is centralizing plural I/O devices into one I/O device. The process will be later described in detail in FIG. 14.

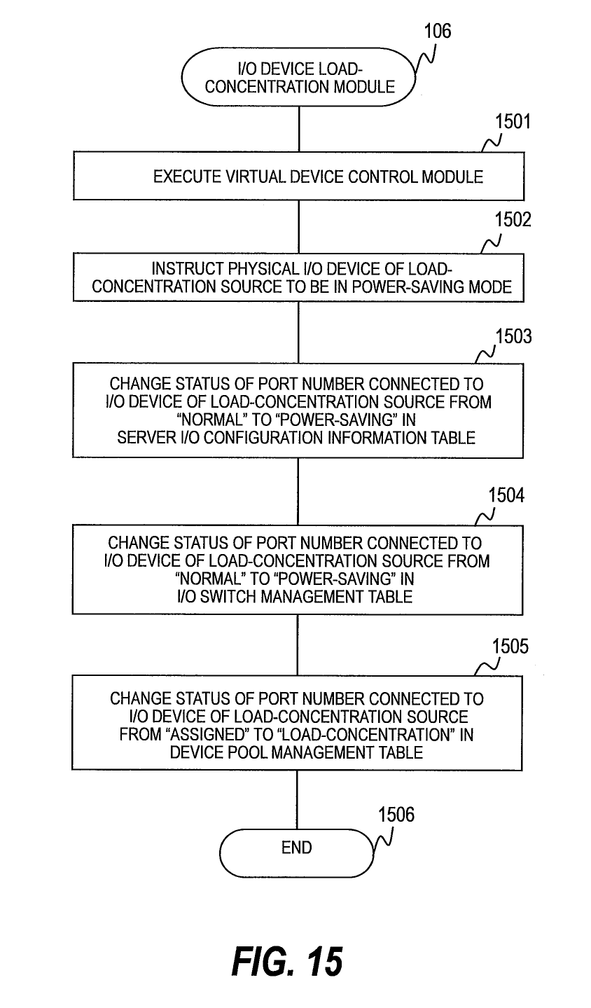

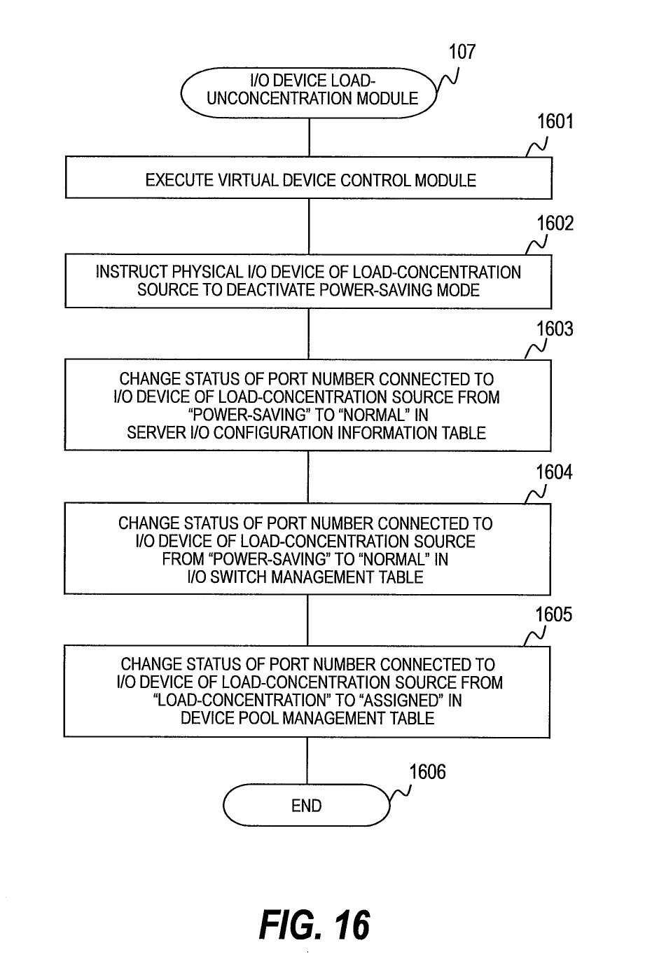

The I/O device load-concentration module 106 performs load-concentration for I/O devices. The process will be later described in detail in FIG. 15. I/O device load-unconcentration module 107 performs load-unconcentration for I/O devices. The process will be later described in detail in FIG. 16.

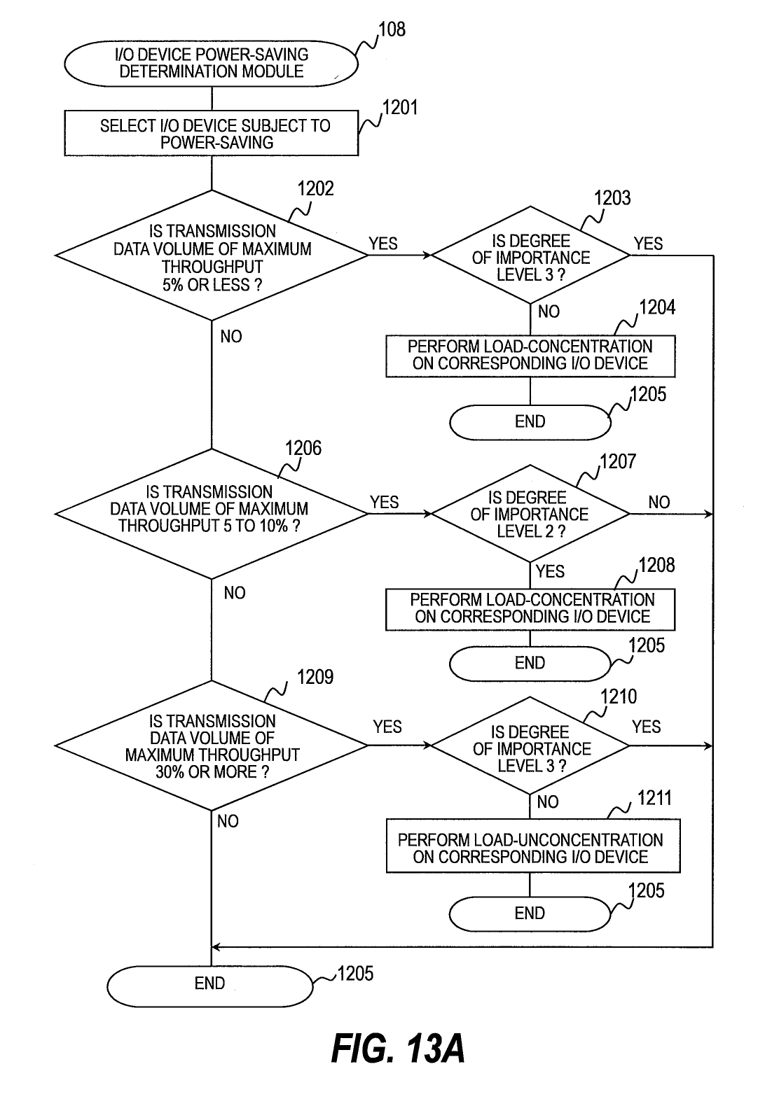

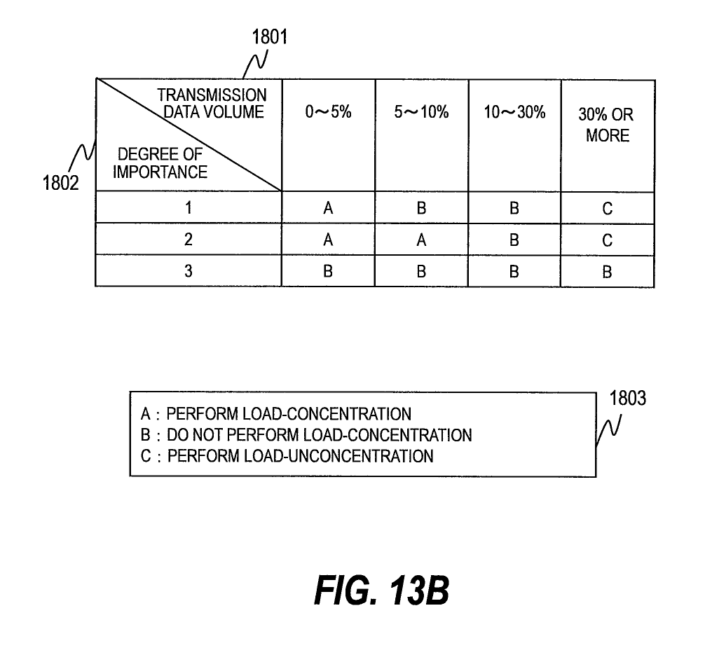

The I/O device power-saving determination module 108 determines as to whether to perform load-concentration for I/O devices. The process will be later described in detail in FIGS. 13A and 13B.

The various pieces of management information include the I/O switch management table 109, the server management table 110, the I/O configuration information table 111 and the device pool management table 112.

The I/O switch management table 109 stores management information on the I/O devices 117 which is connected to I/O switches 115 via sockets 116. The details will be later described in FIG. 6.

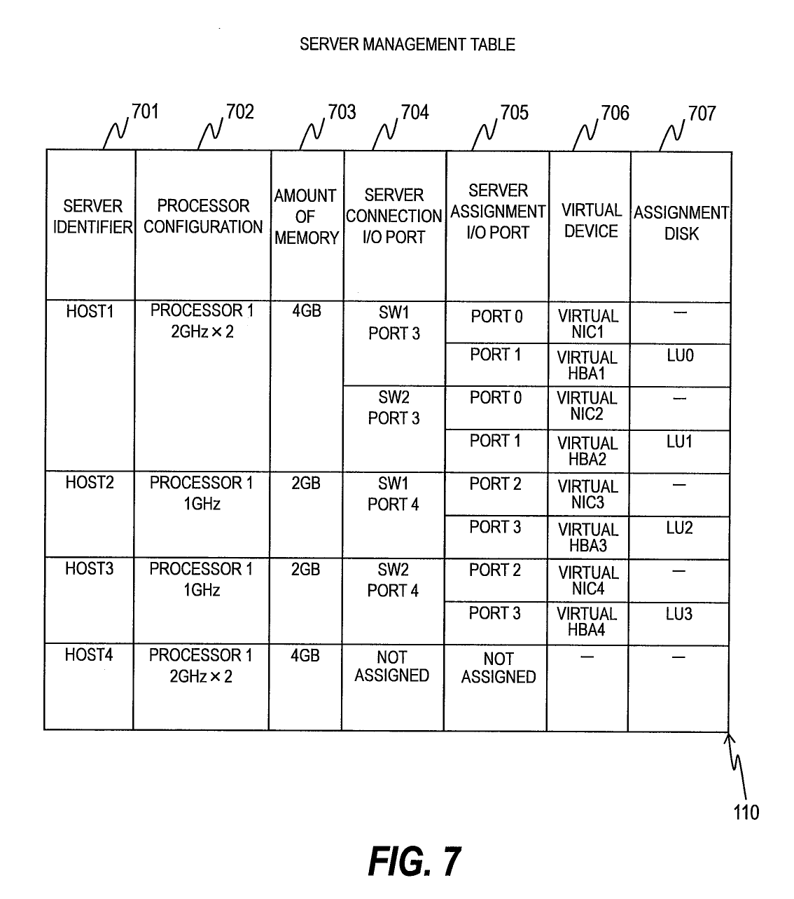

The server management table 110 stores management information on the servers 114 subject to be managed. More specifically, the server management table 110 stores the configuration of the processors provided in the servers 114 and I/O devices in use. The details will be later described in FIG. 7.

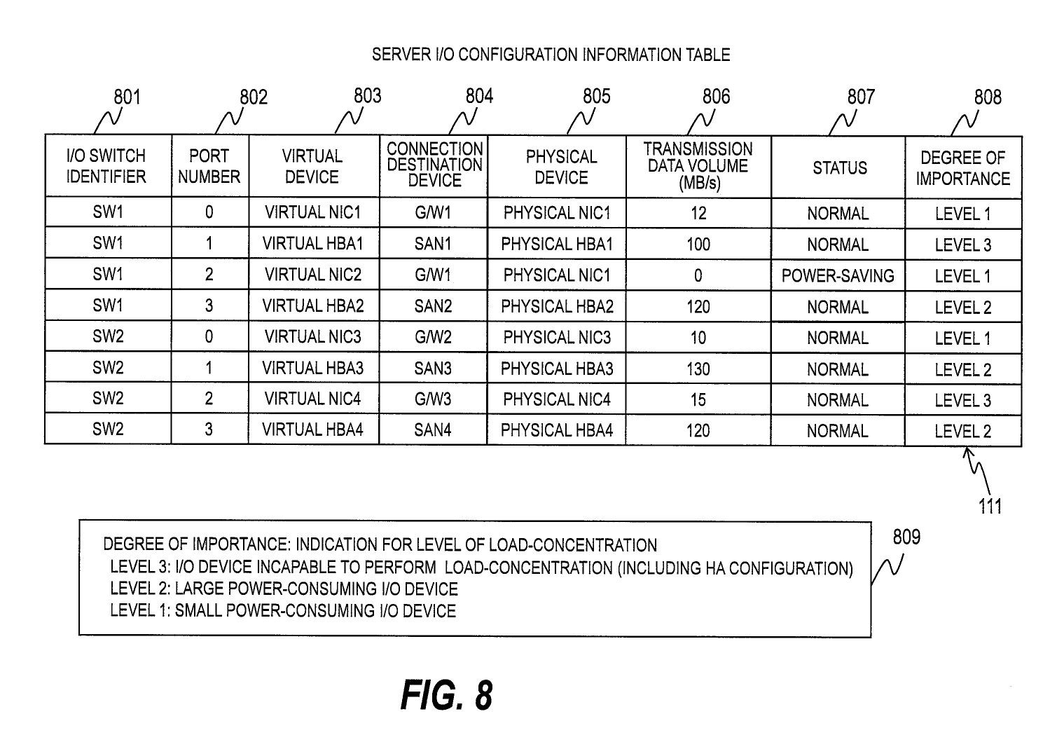

The I/O configuration information table 111 stores an association between the servers 114 subject to be managed and the I/O devices. In addition, status of each of the I/O devices and a degree of importance indicating effects of load-concentration are also stored. The details will be later described in FIG. 8.

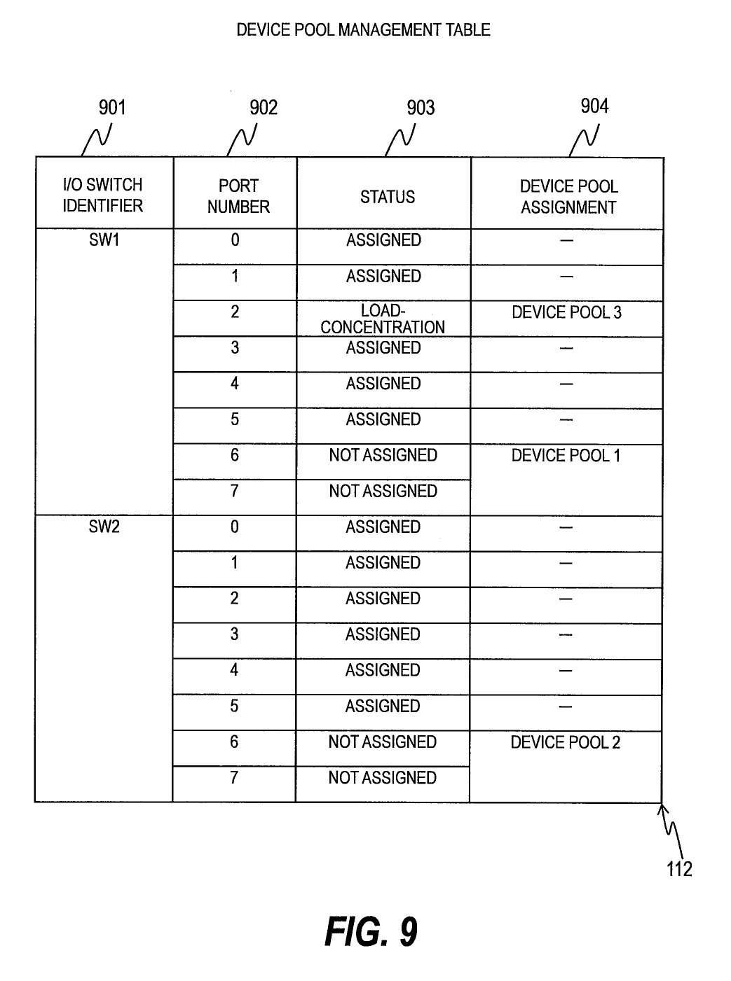

The device pool management table 112 is a table for managing unused I/O devices. The details will be later described in FIG. 9.

FIG. 3 is a diagram showing a configuration of the each server 114 according to the first embodiment of this invention.

The each server 114 comprises a memory 301, a processor 306, an I/O switch interface 307 and a network interface 308.

The memory 301 includes an application 302, an OS 303 and an I/O hypervisor 304. The processor 306 causes the application 302 to execute various task processes on the OS 303.

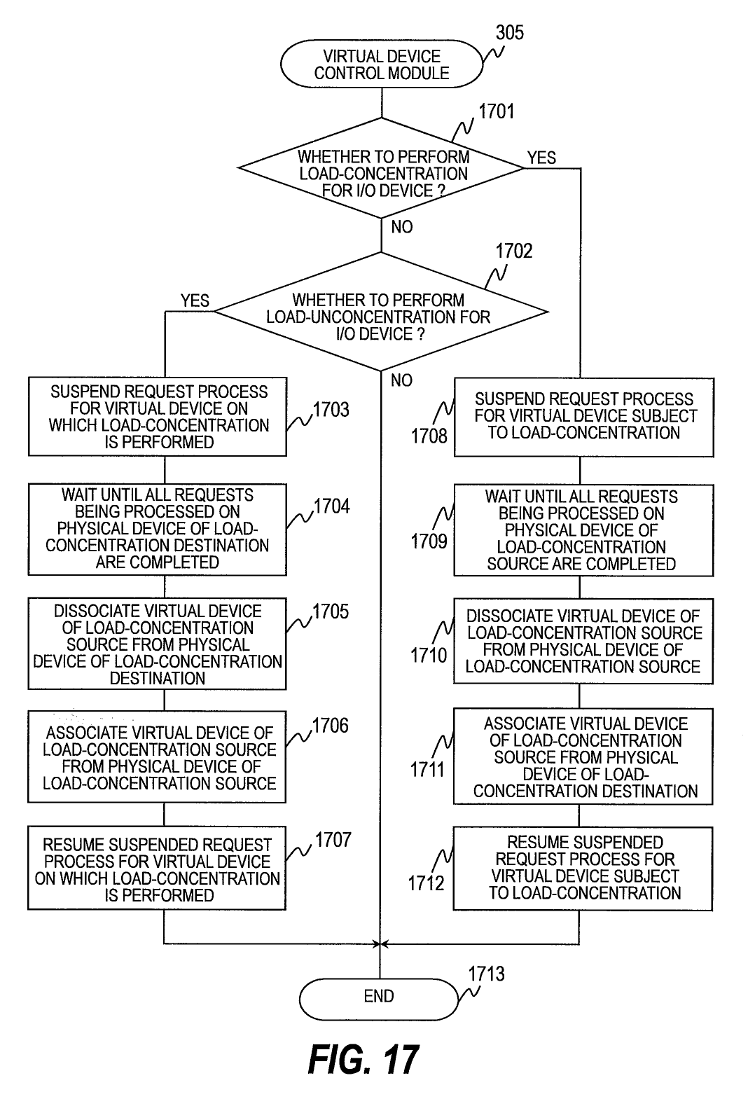

The I/O hypervisor 304 virtualizes the I/O devices by logically dividing the I/O devices used by the servers 114. The I/O hypervisor 304 includes a virtual device control module 305. The virtual device control module 305 changes an association between the virtual device and the physical device. The process performed by the virtual device control module 305 will be later described in FIG. 17. Note that, the SVP 120 described above may virtualize the I/O devices 117 by cooperating with the I/O hypervisor 304.

The processor 306 executes various processes by processing programs such as the application 302 stored in the memory 301.

I/O switch interface 307 is an interface for connecting to the each I/O device 117. The each server 114 is connected to the each storage system 119 via the I/O switch interface 307 to read and write data.

The network interface 308 is connected to the each network switch 113.

FIG. 4 is a diagram showing a configuration of the each storage system 119 according to the first embodiment of this invention.

The each storage system 119 stores data used in the task process performed by the each server 114. The each storage system 119 comprises a storage controller 401, a disk device 402 and an interface 404.

The storage controller 401 controls reading and writing data according to an access request from the each server 114 and the like. The disk device 402 provides logical units (LUs) 403 to which data is read and written. The interface 404 is connected to the SAN and the like and transmits data to and receives data from the each server 114.

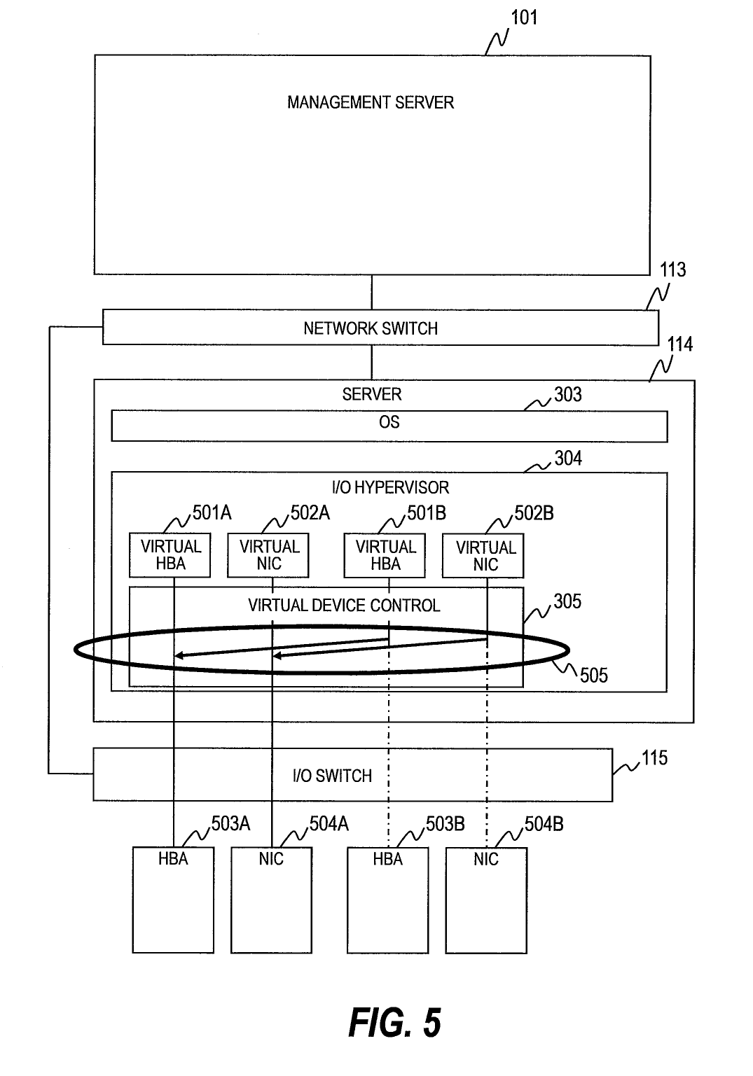

FIG. 5 is an explanatory diagram showing an outline of load-concentration for an I/O device according to the first embodiment of this invention.

The I/O hypervisor 304 provides logical I/O devices and associates the each logical I/O device with each physical I/O device. Moreover, plural logical I/O devices can be associated with one physical I/O device.

The I/O hypervisor 304 uses a virtual HBA 501A, a virtual HBA 501B, a virtual NIC 502A, and a virtual NIC 502B in the each server 114 shown in FIG. 5. The virtual HBA 501A is a logical HBA and assigned to an HBA 503A by the I/O hypervisor 304. Moreover, the HBA 503A is associated with each I/O device 117. Note that, the same applies to the virtual HBA 501B, the virtual NIC 502A and the virtual NIC 502B.

Before load-concentration is performed, the virtual HBA 501A is associated with the HBA 503A, the virtual HBA 501B is associated with an HBA503B, the virtual NIC 502A is associated with an NIC 504A and the virtual NIC 502B is associated with an NIC 504B.

Here, in a case where the management server 101 instructs the I/O hypervisor 304 in the each server 114 to perform the load-concentration for an I/O device, the physical I/O device associated with the virtual HBA501B is changed from the HBA503B to the HBA503A. Similarly, the physical I/O device associated with the virtual NIC502B is changed from the NIC504B to the NIC504A.

As described above, the load-concentration for I/O devices is to centralize the plural logical I/O devices into one physical I/O device. After the load-concentration for the I/O device is performed, the HBA503B and NIC504B go into unused states. Accordingly, the management server 101 instructs the HBA503B and NIC504B to switch to a power-saving mode or shut off the power, thereby reduces power consumption.

FIG. 6 is a diagram showing an I/O switch management table 109 according to the first embodiment of this invention.

The I/O switch management table 109 is a table for managing the each I/O device 117 connected to the each I/O switch 115.

The I/O switch management table 109 includes an I/O switch identifier 601, a port number 602, a connection device 603, a device identifier 604, status 605 and power 606.

The I/O switch identifier 601 is an identifier of the each I/O switch 115. A port is an interface connected to the I/O device. The port number 602 is a number for identifying a port.

The connection device 603 is a type of an I/O device connected to the port. The connection device 603 stores, for example, the NIC and the HBA. In addition, the each server 114 which uses the NIC or the HBA is also recorded.

The device identifier 604 is an identifier of the I/O device connected to the port. For example, if the NIC and the HBA are used, the identifiers stored are a MAC address and a worldwide name (WWN), respectively.

The status 605 is status of a device connected to a port. A value of the status 605 is recorded as “normal” or “not normal”. However, for example, “power-saving” is also recorded in a case where the status of an I/O device is changed to power-saving after the load-concentration.

The power 606 is power consumption of the device connected to the port. The power 606 is updated by the I/O device power monitor module 104 which will be later described.

FIG. 7 is a diagram showing the server management table 110 according to the first embodiment of this invention.

The server management table 110 stores information on the each server 114 managed by the management server 101.

The server management table 110 includes a server identifier 701, a processor configuration 702, an amount of memory 703, a server connection I/O port 704, a server assignment I/O port 705, a virtual device 706 and an assignment disk 707.

The server identifier 701 is an identifier of the each server 114. The processor configuration 702 is configuration information on a processor included in the each server 114. The amount of memory 703 is the amount of memory of a processor included in the each server 114. Note that, the configuration information on the each server 114 may be added to the server management table 110 other than the processor configuration 702 and the amount of memory 703.

The server connection I/O port 704 stores an identifier of the connected port and an identifier of the each I/O switch 115 connected to the each server 114. The server assignment I/O port 705 is an identifier of a port used for the each server 114. A virtual device provided by the I/O hypervisor 304 is assigned to each port.

The virtual device 706 is an identifier of a virtual device provided by the I/O hypervisor 304. The virtual device 706 is associated with the server assignment I/O port 705. The assignment disk 707 records an identifier of the LU provided by the each storage system 119 which is the connection destination in a case where the provided virtual device is the HBA.

FIG. 8 is a diagram showing the server I/O configuration information table 111 according to the first embodiment of this invention.

The I/O configuration information table 111 stores an association between the each server 114 subject to be managed and the each I/O device.

The server I/O configuration information table 111 includes an I/O switch identifier 801, a port number 802, a virtual device 803, a connection destination device 804, a physical device 805, a transmission data volume 806, status 807, and a degree of importance 808.

The I/O switch identifier 801 is an identifier of the each I/O switch 115. The port number 802 is a number for identifying a port of the each I/O switch 115.

The virtual device 803 is an identifier of a virtual device used in the each server 114. The connection destination device 804 is a device connected to the virtual device 803. More specifically, an identifier of a network is stored in a case where the virtual device is the NIC and an identifier of the SAN is stored in a case where the virtual device is the HBA. The physical device 805 is an identifier of the each physical I/O device 117 associated with the virtual device 803.

The transmission data volume 806 is the volume of data transmitted via the virtual device 803. The transmission data volume 806 is periodically collected and recorded.

The status 807 shows status of the virtual device 803. For example, when the virtual device 803 is in the power-saving mode, the “power-saving” is recorded.

When an I/O device is connected to the SAN, if the value of the status 807 is “power-saving”, the each fibre channel switch 118 may determine that the SAN link went down. Accordingly, if the each fibre channel switch 118 reassigns a port, throughput may be decreased because of the large load caused by the reassignment. In that case, if the I/O device is connected to the SAN, and the load-concentration is performed on the I/O device, the each fibre channel switch 118 is notified of the case to prevent the reassignment of the port by the each fibre channel switch 118.

The degree of importance 808 is an indicator for determining conditions to perform the load-concentration on the each virtual device 803. For example, the degree of importance 808 stores “level 3”, “level 2” and “level 1”. More specifically, as shown in a footnote 809, the “level 3” indicates I/O devices on which load-concentration cannot be performed. The load-concentration cannot be performed on the I/O devices of “level 3” regardless the transmission data volume and the power consumption and the “level 3” applies to the I/O devices connected to a standby server with the HA configuration (for redundancy). In addition, in the case of the I/O devices in which traffic rapidly increases or decreases, or in which traffic increases or decreases in a relatively short period, the degree of importance can be set at “level 3” to stabilize the performances of the I/O devices.

The “level 2” indicates large power-consuming I/O devices. Accordingly, the power-saving effect is large after the load-concentration is performed, and thus, load-concentration is actively performed. An example of the large power-consuming I/O devices is the HBA. The “level 1” indicates small power-consuming I/O devices. Accordingly, the power-saving effect is small after the load-concentration is performed, and thus, the load-concentration is performed when the transmission data volume transmission data volume is extremely small.

Note that, the degree of importance 808 may be set automatically based on values of the power 606 in the I/O switch management table 109 or may be set manually by an administrator.

FIG. 9 is a diagram showing a device pool management table 112 according to the first embodiment of this invention.

The device pool management table 112 manages I/O devices 117 which are unused. In a case where load-unconcentration is performed, the status of the I/O device on which the load-concentration is performed can be returned to where the load-unconcentration was performed by referring to the device pool management table 112.

The device pool management table 112 includes an I/O switch identifier 901, a port number 902, status 903 and a device pool assignment 904.

The I/O switch identifier 901 is an identifier of the each I/O switch 115. The port number 902 is a number for identifying a port of the each I/O switch 115.

The status 903 indicates status of the each I/O device 117 assigned to the port of the each I/O switch 115. More specifically, “load-concentration” indicating an unused device due to load-concentration is recorded, other than “assigned” and “not assigned”. The device pool assignment 904 is an identifier of an unused device group.

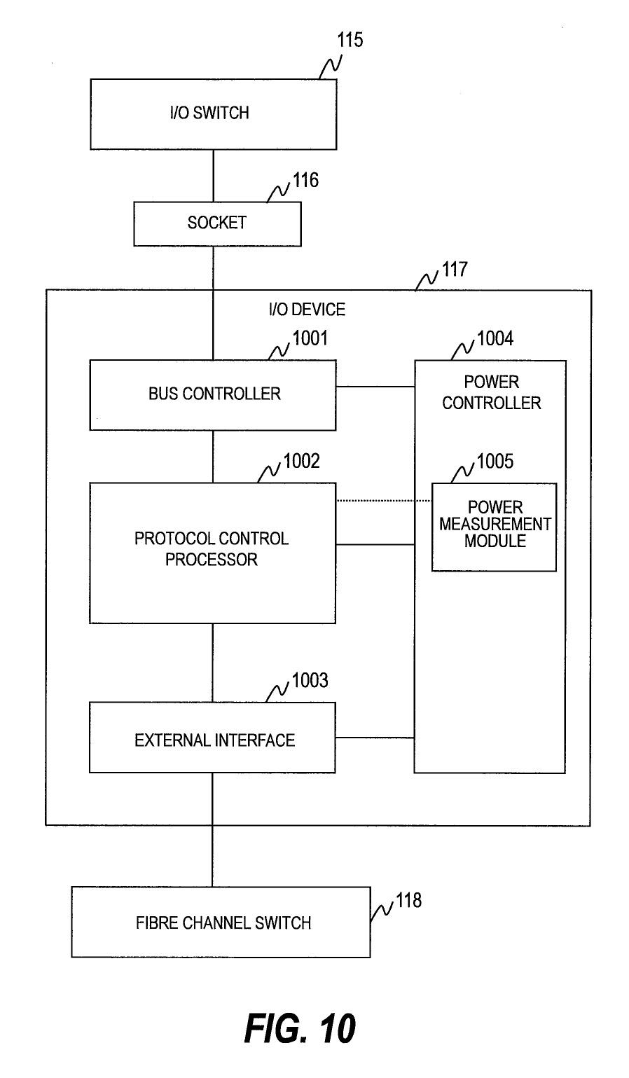

FIG. 10 is a diagram showing a configuration of the each I/O device 117 according to the first embodiment of this invention.

The each I/O device 117 is connected to the each I/O switch 115 via the each socket 116.

The each I/O device 117 includes a bus controller 1001, a protocol control processor 1002, an external interface 1003 and a power controller 1004.

The bus controller 1001 controls data transmission between each component included in the each I/O device 117. The protocol control processor 1002 executes instructed processes according to commands transmitted from the management server 101 and the like. The external interface 1003 is connected to a network and the like. FIG. 10 shows the external interface 1003 connected to the SAN and to the each storage system 119 via the each fibre channel switch 118.

The power controller 1004 performs power control such as providing power to the each component of the each I/O device 117. The power controller 1004 includes a power measurement module 1005, and thus, the each I/O device can measure its own power consumption.

In a case where the each I/O device 117 receives a command to obtain a value of power transmitted from the management server 101 or the each server 114, the protocol control processor 1002 gives an instruction to the power measurement module 1005 in the power controller 1004 first. Subsequently, the power measurement module 1005 measures the power consumption of the corresponding I/O device 117 and notifies the protocol control processor 1002 of a measurement result. The protocol control processor 1002 then transmits the measurement result to the transmitter of the command.

FIG. 11 is a flowchart showing a process of an entire power control process of the each I/O device according to the first embodiment of this invention.

The processor 202 in the management server 101 executes the I/O device power control module 103 in order to perform the power control process on the each I/O device. In this process, determination is made whether the load-concentration or the load-unconcentration is performed for all the I/O devices subject to be managed. The load-concentration or the load-unconcentration is performed according to the determination.

The processor 202 in the management server 101 first executes the I/O device power monitor module 104 (Step 1101). In the process of the I/O device power monitor module 104, power consumption of the each I/O device 117 connected to the each I/O switch 115 is obtained in order to determine whether to perform the load-concentration or load-unconcentration. The process will be later described in detail in FIG. 12. Note that, the information for determining whether to perform the load-concentration or load-unconcentration may be the data volume transmitted via the corresponding I/O device as described above, other than the power consumption. Accordingly, in the process of the Step 1101, a load volume of the each I/O device 117 may be measured and collected other than the power consumption.

The processor 202 in the management server 101 then executes the I/O device power-saving determination module 108 (Step 1102). In the I/O device power-saving determination module 108, determination is made whether the each I/O device is in a state where power-saving control is possible. Subsequently, if the each of the I/O device is in a state where power-saving control is possible, determination is made whether power-saving control is actually performed. The process will be later described in detail in FIG. 13A.

The processor 202 in the management server 101 determines whether load-concentration for the each I/O device is performed based on an execution result of the I/O device power-saving determination module 108 (Step 1103).

The processor 202 in the management server 101 executes the I/O device selection module 105 that selects the each I/O device on which the load-concentration can be performed (Step 1104) if the load-concentration on the each I/O device is performed (The result of Step 1103 is “YES”). The process of the I/O device selection module 105 will be later described in detail in FIG. 14.

The processor 202 in the management server 101 further executes I/O device load-concentration module 106 for the each I/O device on which performing the load-concentration is possible (Step 1105). The process of the I/O device load-concentration module 106 will be later described in detail in FIG. 15.

The processor 202 in the management server 101 determines whether to perform load-unconcentration on the each I/O device based on the execution result of the I/O device power-saving determination module 108 (Step 1106), if the load-unconcentration on the each I/O device is not performed (The result of Step 1103 is “NO”) or if the load-unconcentration on the each I/O device is completed.

The processor 202 in the management server 101 executes the I/O device load-unconcentration module 107 which performs load-unconcentration on the each I/O device (Step 1107), if the load-unconcentration of the each I/O device is performed (The result of Step 1106 is “YES”). The process of the I/O device load-unconcentration module 107 will be later described in detail in FIG. 16.

The processor 202 in the management server 101 determines whether an instruction to suspend the power control process on the each I/O device is received (Step 1108). In a case where the instruction for the suspension is received (The result of Step 1108 is “YES”), this process is completed (Step 1109). In a case where the instruction for the suspension is not received (The result of Step 1108 is “NO”), the process in Step 1101 is executed again and the consumption power of the each I/O device 117 is routinely monitored.

FIG. 12 is a flowchart showing a process of monitoring power consumption of the each I/O device by the I/O device power monitor module 104 according to the first embodiment of this invention.

The processor 202 in the management server 101 transmits a command to the each I/O device 117 via the each server 114 in order to obtain the power consumption. The each I/O device 117 received the command measures the power consumption using the power measurement module 1005 and transmits a measurement result to the management server 101 (Step 1301).

The processor 202 in the management server 101 updates the power 606 in the I/O switch management table 109 in a case where the processor 202 in the management server 101 receives the power consumption of the each I/O device 117 (Step 1302). At this time, in a case where there is no response from the each I/O device 117 after transmitting the command, the status is determined to be “not normal” and the status 605 may be updated. Moreover, the status 605 may be updated at different timing. After the power 606 in the I/O switch management table 109 is updated, this process is completed (Step 1303).

FIG. 13A is a flowchart showing a process of determining whether power-saving control on the each I/O device 117 is performed by the I/O device power-saving determination module 108 according to the first embodiment of this invention.

In the first embodiment of this invention, whether to perform the power-saving control (performing load-concentration or load-unconcentration) is determined based on the degree of importance for the each I/O device and the data volume transmitted to the each I/O device.

The processor 202 in the management server 101 selects I/O devices subject to power consumption control (Step 1201). At this time, the I/O devices on which the power consumption control cannot be performed are excluded from the I/O devices subject to power consumption control. Moreover, in a case where the plural virtual I/O devices are associated with one physical I/O device, all the virtual I/O devices are necessary to be reassigned to another physical I/O device, and thus, the plural virtual I/O devices are excluded from the I/O devices subject to power consumption control. Note that, this process is executed for all the I/O devices subject to power consumption control.

The processor 202 in the management server 101 obtains data volume transmitted via the I/O devices selected in the process of Step 1201 and determines whether the transmission data volume is not more than 5% of the maximum throughput (Step 1202.) In other words, the status in which the transmission data volume is not more than 5% of the maximum throughput indicates a status in which the loads of the I/O devices are small. Accordingly, if the load-concentration can be performed, the power consumption can be reduced without decreasing the throughput. In the first embodiment of this invention, the status for small load indicates load volume of 5%; however, the value may be set suitable for a system.

The processor 202 in the management server 101 determines whether the transmission data volume is not more than 5% of the maximum throughput (The result of Step 1202 is “YES”), and further determines whether the degree of importance 808 of the I/O devices is “level 3” (Step 1203). In a case where the degree of importance 808 of the I/O devices is “level 3” (The result of the Step 1203 is “YES”), the load-concentration on the I/O devices cannot be performed. Accordingly, this process is completed (Step 1205).

The processor 202 in the management server 101 determines to perform load-concentration on the I/O devices subject to power consumption control because the power-saving effect is expected after the load-concentration is performed if the degree of importance 808 of the I/O devices is not “level 3” (The result of the Step 1203 is “NO”.) This process is then completed (Step 1205).

On the other hand, if the processor 202 in the management server 101 determines that the transmission data volume exceeds 5% of the maximum throughput (The result of the Step 1202 is “NO”), the processor 202 in the management server 101 determines whether the transmission data volume is not more than 10% (Step 1206). In other words, the status in which the transmission data volume is not more than 10% of the maximum throughput indicates a status in which the loads of the I/O devices are relatively small. Accordingly, the power-saving effect can be expected for the I/O devices with large power consumption by performing the load-concentration.

The processor 202 in the management server 101 determines whether the degree of importance 808 of the I/O devices is “level 2” (Step 1207) in a case where the transmission data volume is not more than 10% of the maximum throughput (The result of Step 1206 is “YES”). In a case where the degree of importance 808 is determined to be “level 2” (The result of Step 1207 is “YES”), the power consumption of the corresponding I/O device is large and the power-saving effect can be expected after performing the load-concentration, and thus, the load-concentration is determined to be performed on the I/O devices subject to the load-concentration. This process then is completed (Step 1205).

If the processor 202 in the management server 101 determines that the transmission data volume is not less than 10% of the maximum throughput (The result of the Step 1206 is “NO”), the processor 202 in the management server 101 determines whether the transmission data volume is not less than 30% (Step 1209). In other words, the processor 202 in the management server 101 determines whether more than a certain amount of load is on the I/O devices. In a case where the transmission data volume is not more than 30% of the maximum throughput (The result of the Step 1209 is “NO”), this process is completed (Step 1205).

The processor 202 in the management server 101 determines whether the transmission data volume is not less than 30% of the maximum throughput (The result of Step 1209 is “YES”), and further determines whether the degree of importance 808 of the I/O devices is “level 3” (Step 1210). In a case where the degree of importance 808 of the I/O devices is “level 3” (The result of the Step 1210 is “YES”), the power-saving control is not performed, and thus, this process is completed (Step 1205).

The processor 202 in the management server 101 determines to perform load-unconcentration if the load-concentration is performed on the I/O devices in order to prevent the throughput from a decrease caused by the load-concentration in a case where the degree of importance 808 of the I/O devices is not “level 3” (The result of the Step 1210 is “NO”.) This process is then completed (Step 1205).

FIG. 13B is a table showing determining whether power control on the I/O device is performed by the I/O device power-saving determination module 108 according to the first embodiment of this invention.

The table shown in FIG. 13B is a summary of determination results of power-saving control performed by the I/O device power-saving determination module 108. In the first embodiment of this invention, determination as to whether to perform power-saving control is made based on a transmission data volume 1801 and a degree of importance 1802 of the each I/O device. Note that, as shown in note 1803, “A” indicates that the load-concentration is performed; “B” indicates that the load-concentration is not performed and “C” indicates that the load-unconcentration is performed.

As shown in the table in FIG. 13B, only in a case where the transmission data volume 1801 is not more than 5%, the load-concentration is performed on the I/O devices of which degree of importance 1802 is “level 1” and which has small power consumption. Meanwhile, in a case where the transmission data volume 1801 is not more than 10%, the load-concentration is performed on the I/O devices of which degree of importance 1802 is “level 2” and which has large power consumption. In addition, in any of the above cases, in a case where the transmission data volume is not less than 30% of the maximum throughput, the load-unconcentration is performed to prevent the throughput to decrease. Note that, in a case where the degree of importance 1802 is “level 3”, no load-concentration or load-unconcentration is performed.

In the first embodiment of this invention, utilization ratios (the amount of load) of the each I/O devices are monitored to control performing the load-concentration and load-unconcentration. More specifically, the transmission data volume for each virtual device is a subject to be monitored; however, other information may be also subject to be monitored. For example, transmission data volume for each physical device may be a subject to be monitored. Moreover, the information may be time taken for an I/O process or the number of packets processed for the each virtual device or the each physical device. In addition, in the first embodiment of this invention, although the subject to be monitored is the same for different types of the I/O devices, the subject to be monitored may be set to a large power consumption decrease effect for each type of I/O devices.

FIG. 14 is a flowchart showing a process of selecting the each I/O device subject to load-concentration by the I/O device selection module 105 according to the first embodiment of this invention.

The processor 202 in the management server 101 extracts an I/O device, on which the load-concentration is to be performed, determined by the I/O device power-saving determination module 108, and the I/O devices which have the same connection devices 603, from the I/O switch management table 109 (Step 1401).

Moreover, the processor 202 in the management server 101 extracts the I/O device subject to load-concentration and I/O devices which have the same connection destination devices 804 among the I/O devices selected in the process of Step 1401 (Step 1402). More specifically, I/O devices are extracted from the server I/O configuration information table 111 based on the I/O switch identifier 601 and the port number 602 of the I/O device extracted from the I/O switch management table 109. Subsequently, the I/O devices having the same connection destination device 804 of the I/O device subject to load-concentration are extracted.

The processor 202 in the management server 101 notifies a user of the I/O devices extracted in Step 1402 and the information on the I/O devices (Step 1403).

The processor 202 in the management server 101 determines whether automatically or manually to select the I/O devices (load-concentration destinations) which are extracted in the process of Step 1402, and on which the load-concentration can be performed (Step 1404). The user may specify automatically or manually select the I/O devices (load-concentration destinations) in a setting file in advance or the user may input the selection.

The processor 202 in the management server 101 selects an I/O device of the load-concentration destination which matches most with conditions from the extracted I/O devices on which the load-concentration can be performed (Step 1405) in a case where the I/O device of the load-concentration destination is automatically selected (The result of Step 1404 is “automatic”). More specifically, an I/O device in which the transmission data volume does not exceed a predetermined threshold after the load-concentration is performed is selected in order to avoid a decrease in the throughput after the load-concentration is performed. Moreover, an I/O device of which power consumption is the least after the load-concentration is performed may be selected in a case where the power consumption after the load-concentration is performed can be predicted. In other words, the conditions set in the process of Step 1405 are determined based on an allowable range of the throughput after the load-concentration is performed, the power consumption decrease effect and the like.

The processor 202 in the management server 101 receives an instruction to select an I/O device of the load-concentration destination from the extracted I/O devices on which the load-concentration can be performed (Step 1406) in a case where the I/O device of the load-concentration destination is manually selected (The result of Step 1404 is “manual”). In other words, the user selects an appropriate I/O device in a case where the I/O device of the load-concentration destination is manually selected.

The processor 202 in the management server 101 determines the selected I/O device to be the I/O device of the load-concentration destination (Step 1407). This process is then completed (Step 1408).

FIG. 15 is a flowchart showing a process of performing load-concentration on the I/O device by the I/O device load-concentration module 106 according to the first embodiment of this invention.

In this process, switching of the status of the I/O device subject to the load-concentration and of the mode of the I/O device on which the load-concentration are performed to a power-saving mode.

The processor 202 in the management server 101 instructs the each server 114 to execute the virtual device control module 305 and performs the load-concentration of the I/O device subject to load-concentration (Step 1501).

The processor 202 in the management server 101 instructs the physical I/O device of the load-concentration source to switch to the power-saving mode after the load-concentration on the I/O device is completed (Step 1502). At this time, the power of the I/O device may be shut off instead of switching to the power-saving mode.

In addition, the processor 202 in the management server 101 updates statuses in each table after the load-concentration is performed.

The processor 202 in the management server 101 changes the record corresponding to the status 807 in the server I/O configuration information table 111 regarding the port of the each I/O switch 115 connected to the I/O device of the load-concentration source from “normal” to “power-saving” (Step 1503). At this time, the connection device is notified of the change in the status. More specifically, the connection device may be notified of the change after the change is made in the status 807 in the server I/O configuration information table 111 or notified in conjunction with the change in the status 807 in the server I/O configuration information table 111.

The processor 202 in the management server 101 changes the record corresponding to the status 605 in the I/O switch management table 109 regarding the port of the each I/O switch 115 connected to the I/O device of the load-concentration source from “normal” to “power-saving” (Step 1504). The each I/O switch 115 is notified of the change in the status by changing the status 605 in the I/O switch management table 109. At this time, the each I/O switch 115 is notified of the change in the status. More specifically, the each I/O switch 115 may be notified of the change after the change is made in the status 605 in the I/O switch management table 109 or notified in conjunction with the change in the status 605 in the I/O switch management table 109.

The processor 202 in the management server 101 changes the record corresponding to the status 903 in the device pool management table 112 regarding the port of the each I/O switch 115 connected to the I/O device of the load-concentration source from “assigned” to “load-concentration” (Step 1505). The status 903 of the I/O device of load-concentration source can be returned to the original status by changing the record in the status 903 to “load-concentration” in a case where the load-unconcentration is performed.

As described above, after the status in each table is updated after the load-concentration is performed, this process is completed (Step 1506).

FIG. 16 is a flowchart showing a process of performing load-unconcentration on the I/O device by the I/O device load-unconcentration module 107 according to the first embodiment of this invention.

The processor 202 in the management server 101 instructs the each server 114 to execute the virtual device control module 305 and performs the load-unconcentration of the I/O device subject to load-concentration (Step 1601).

The processor 202 in the management server 101 instructs the physical I/O device of the load-concentration source to deactivate the power-saving mode after the load-unconcentration on the I/O device is completed (Step 1602). Note that, in a case where the power of I/O device is off, the I/O device is powered on again.

In addition, the processor 202 in the management server 101 updates the status in each table after the load-unconcentration is performed.

The processor 202 in the management server 101 changes the record corresponding to the status 807 in the server I/O configuration information table 111 regarding the port of the each I/O switch 115 connected to the I/O device of the load-concentration source from “power-saving” to “normal” (Step 1603). As described above, the connection device is notified of the change in the status at timing of changing the status 807 in the server I/O configuration information table 111.

The processor 202 in the management server 101 changes the record corresponding to the status 605 in the I/O switch management table 109 regarding the port of the each I/O switch 115 connected to the I/O device of the load-concentration source from “power-saving” to “normal” (Step 1604). As described above, the each I/O switch 115 is notified of the change in the status at timing of changing the status 605 in the I/O switch management table 109.

The processor 202 in the management server 101 changes the record corresponding to the status 903 in the device pool management table 112 regarding the port of the each I/O switch 115 connected to the I/O device of the load-concentration source from “load-concentration” to “assigned” (Step 1605).

As described above, after the status in each table is updated after the load-concentration is performed, this process is completed (Step 1606).

FIG. 17 is a flowchart showing a process of performing load-unconcentration and load-unconcentration on the I/O device by the virtual device control module 305 according to the first embodiment of this invention.

The virtual device control module 305 is executed by the I/O device load-concentration module 106 and the I/O device load-unconcentration module 107 described above. The virtual device control module 305 executes a process of associating the virtual device and the physical device.

The processor 306 in the each server 114 determines whether to perform the load-concentration on the I/O device (Step 1701). In a case where the load-concentration on the I/O device is performed (The result of Step 1701 is “YES”), processes after Step 1708 are executed. On the other hand, in a case where the load-concentration on the I/O device is not performed (The result of Step 1701 is “NO”), determination is made whether the load-unconcentration on the I/O device is performed (Step 1702). In a case where load-unconcentration on the I/O device is to be performed (The result of Step 1702 is “YES”), processes after Step 1703 are executed.

The processor 306 in the each server 114 suspends a request process for the virtual device subject to load-concentration (a load-concentration source) in a case where the load-concentration on the I/O device is performed (Step 1708). Moreover, the processor 306 in the each server 114 waits until all the requests being processed on the physical device associated with the virtual device subject to load-concentration are completed (Step 1709).

The processor 306 in the each server 114 dissociates the virtual device subject to load-concentration from the associated physical device (Step 1710). Moreover, the virtual device subject to load-concentration and the physical device of load-concentration are associated (Step 1711). Subsequently, the processor 306 in the each server 114 resumes the suspended request process for the virtual device subject to load-concentration (Step 1712).

The processor 306 in the each server 114, on the other hand, suspends a request process for the virtual device subject to load-unconcentration (a load-concentration source) in a case where the load-unconcentration on the I/O device is performed (Step 1703). Moreover, the processor 306 in the each server 114 waits until all the requests being processed on the physical device on which load-concentration of the virtual device subject to load-concentration is performed are completed (Step 1704). Note that, subsequent processes may be executed after the request process for the virtual device subject to load-unconcentration is completed.

The processor 306 in the each server 114 dissociates the virtual device subject to load-unconcentration from the associated physical device on which load-concentration of the virtual device subject to load-unconcentration is performed (Step 1705). Moreover, the processor 306 in the each server 114 associates the virtual device subject to load-unconcentration with the physical device to which the virtual device subject to load-unconcentration has been assigned (Step 1706). The physical device to which the virtual device subject to load-unconcentration has been assigned can be identified by referring to the device pool management table 112. Subsequently, the processor 306 in the each server 114 resumes the suspended request process for the virtual device subject to load-unconcentration (Step 1707).

According to the first embodiment of this invention, the power consumption of the computer system can be decreased by centralizing (load-concentration) I/O devices having small loads and switching unused I/O devices to a power-saving mode. For example, for the system in which loads vary with time, the power consumption can be decreased by performing the load-concentration on I/O devices during the time when the loads are small, and by performing the load-unconcentration on I/O devices during the time when the loads are large. Accordingly, the processing performance can be maintained.

### A Second Embodiment

In a second embodiment, described is a process for selecting an I/O device subject to load-concentration based on path information (topology information) on a connection destination of a virtual device. Note that, the same descriptions with the first embodiment are omitted as necessary.

The computer system and each device in the second embodiment are same as the computer system and the each device shown in FIGS. 1 to 4 and 10 in the first embodiment. In addition, an I/O device management module 102 and each piece of management information stored in a memory in a management server 101 are also the same except for an I/O device selection module 105 and a server management table 110.

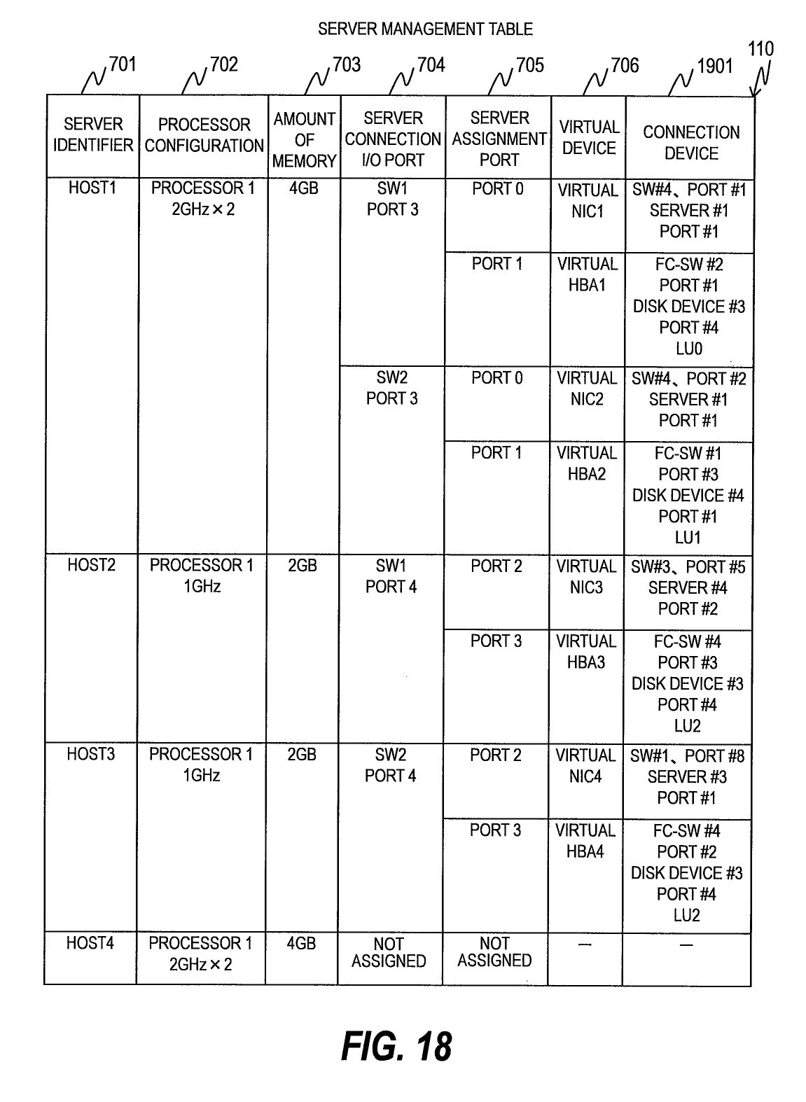

FIG. 18 is a diagram showing the server management table 110 according to a second embodiment of this invention.

The server management table 110 in the second embodiment includes a connection device 1901 in addition to the columns of the server management table 110 in the first embodiment.

The connection device 1901 includes information on ports going through devices of the terminal connection destination. For example, a “virtual NIC1” of a “HOST1” is terminally connected to a port of a port number #1 of a server (#1). The “virtual NIC1” is connected via port of a port number #1 of an I/O switch (SW #4).

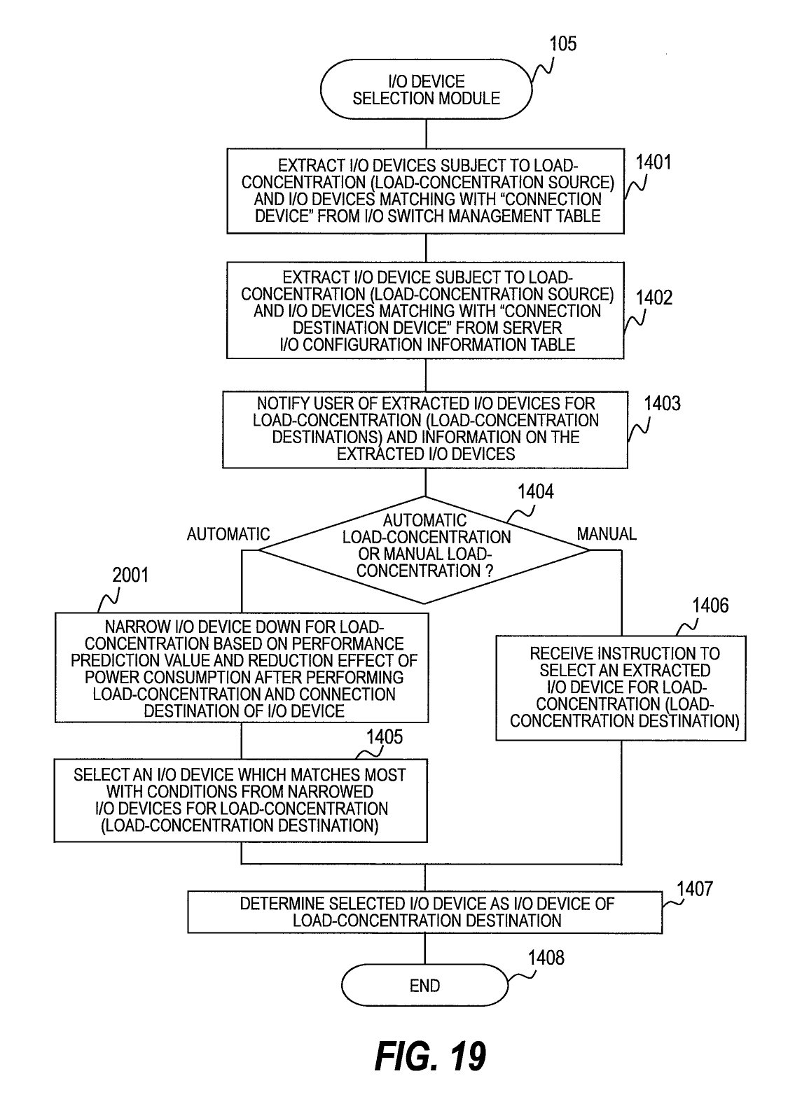

FIG. 19 is a flowchart showing a process of selecting an I/O device subject to load-concentration by the I/O device selection module 105 according to the second embodiment of this invention.

The second embodiment differs from the first embodiment in selecting the I/O device automatically using the topology information. More specifically, before the process of Step 1405, the processor 202 in the management server 101 predicts performance and a power consumption decrease effect of after load-concentration, and narrows down the I/O devices to one I/O device of a load-concentration source (Step 2001).

More specifically, the processor 202 in the management server 101 is capable of predicting changes in performance for the entire connection path. There may be a device which is a bottleneck on the connection path even though the transmission data volume is small compared to a maximum throughput of a physical device of a load-concentration destination of a virtual device.

In addition, the processor 202 in the management server 101 is capable of decreasing the power consumption of the entire computer system by performing load-concentration in order to have unused devices on the connection path.

Furthermore, the processor 202 in the management server 101 is capable of narrowing down to an I/O device of a load-concentration source so that the port is connected to the same connection destination after the load-concentration is performed by using the topology information.

According to the second embodiment of this invention, in addition to the effects described in the first embodiment, the power consumption decrease effect and predicting changes in performance of after the load-concentration can be achieved. Moreover, the decrease in power consumption of the computer system can be also achieved.

While the present invention has been described in detail and pictorially in the accompanying drawings, the present invention is not limited to such detail but covers various obvious modifications and equivalent arrangements, which fall within the purview of the appended claims.

What is claimed is:

1. A power control method executed in a computer system including: an input/output switch coupled to a plurality of input/output devices; a server which is coupled to the input/output switch, and which uses the plurality of input/output devices; and a management computer coupled to the input/output switch and the server,
wherein the management computer comprises: an interface coupled to the input/output switch and the server; a processor coupled to the interface; and a memory coupled to the processor,
wherein the management computer is configured to: manage pieces of management information including a port of the input/output switch coupled to the each of the plurality of input/output devices, an association of a device coupled to the each of the plurality of input/output devices, and a usage ratio of the each of the plurality of input/output devices, and
wherein the power control method includes the steps of: selecting at least one of the input/output devices of which the usage ratio is smaller than a first predetermined threshold according to the pieces of management information; and processing, by another input/output device coupled to the input/output switch, a request for the selected input/output device.

2. The power control method according to claim 1,
wherein the computer system is configured to provide a logical input/output device assigned to a physical input/output device by virtualizing the selected input/output device, and
wherein the power control method further includes the step of processing, by the another input/output device, the request for the selected input/output device by assigning a different physical input/output device to the logical input/output device associated with the selected input/output device.

3. The power control method according to claim 1,
wherein the each of the plurality of input/output devices is switchable to a power-saving mode which decreases power consumption, and
wherein the power control method further includes the step of switching the selected input/output device to the power-saving mode.

4. The power control method according to claim 1, further including the step of shutting off power of the selected input/output device.

5. The power control method according to claim 1, further including the step of processing, by the selected input/output device, the request for the selected input/output device in a case where an usage ratio of the another input/output device is larger than a second predetermined threshold.

6. The power control method according to claim 1,
wherein the management computer is configured to manage a path information on devices coupled to the server, and
wherein the power control method includes the step of selecting the input/output device according to the path information.

7. The power control method according to claim 1, further including the step of selecting the input/output device according to an amount of power consumed by the input/output device.

8. The power control method according to claim 1,
wherein the usage ratio is determined according to a volume of data transferred via the input/output device.

9. The power control method according to claim 1,
wherein the first predetermined threshold is determined according to at least one of the amount of power consumed by the input/output device and a connection destination of the input/output device.

10. The power control method according to claim 1,
wherein the usage ratio and the first predetermined threshold are set according to a type of the input/output device.

11. A computer system including: an input/output switch coupled to a plurality of input/output devices; a server which is coupled to the input/output switch, and which uses the plurality of input/output devices; and a management computer coupled to the input/output switch and the server,
wherein the management computer comprises: an interface coupled to the input/output switch and the server; a processor coupled to the interface; and a memory coupled to the processor,
wherein the management computer is configured to manage pieces of management information including a port of the input/output switch coupled to the each of the plurality of input/output devices, an association of a device coupled to the each of the plurality of input/output devices, and a usage ratio of the each of the plurality of input/output devices,
select at least one of the input/output device of which the usage ratio is smaller than a predetermined threshold according to the pieces of management information, and
set another input/output device coupled to the input/output switch to process a request for the selected input/output device.

12. A management computer coupled to an input/output switch coupled to a plurality of input/output devices and a server which is coupled to the input/output switch, and which uses the plurality of input/output devices, comprising: an interface coupled to the input/output switch and the server; a processor coupled to the interface; and a memory coupled to the processor,
wherein the processor is configured to:
manage pieces of management information including a port of the input/output switch coupled to the each of the plurality of input/output devices, an association of a device coupled to the each of the plurality of input/output devices, and a usage ratio of the each of the plurality of input/output devices;
select at least one of the input/output devices of which the usage ratio is smaller than a predetermined threshold according to the pieces of management information; and
set another input/output device coupled to the input/output switch to process a request for the selected input/output device.
